(19) United States
(12) Patent Application Publication
(10) Pub. No.: US 2008/0172776 A1
(43) Pub. Date: Jul. 24, 2008

(54) Bi-directional card holder

(75) Inventor: Cliff Webster, Walnut Creek, CA (US)

Correspondence Address: ADAMS LAW OFFICE, 1867 YGNACIO VALLEY RD. #230, WALNUT CREEK, CA, 94598, US

(73) Assignee: Image Sales, Inc, Walnut Creek, CA (US)

(21) Appl. No.: 12/004,838

(22) Filed: Dec. 20, 2007

Related U.S. Application Data
(60) Provisional application No. 60/875,721, filed on Dec. 20, 2006.

(51) Int. Cl. A42B 1/24; G09F 3/00

(52) U.S. Cl. 2/422; 40/329

(57) ABSTRACT

A bi-directional information card holder that can hold one or more differently sized information cards in both the landscape and portrait orientation. In some embodiments the card holder is permanently attached to either a hardhat or a soft hat. In some embodiments, the cardholder is connected with a hardhat through a curve. In other embodiments the card holder is removeably attached to either a hardhat or a soft hat. In some embodiments, there is a clear, rigid protective plate that covers and protects the information card.

This application claims priority to U.S. Provisional Patent Application 60/875,721 filed Dec. 20, 2006, which is herein incorporated by reference in its entirety.

### BACKGROUND OF THE INVENTION

1. Field of the Invention

The invention relates generally to head coverings connected with a bi-directional card holder that is capable of securely holding one or more cards in both portrait and landscape orientation, where the cards may contain worker identification information or other relevant information, as desired.

2. Description of the Related Art

Worker safety is an important issue at various job sites. Often, hardhats or other protective headgear are used to protect workers at construction sites, while fighting fires, and in other circumstances. Some existing hardhats provide for a card containing worker identification or worker qualification information, and there are many patents directed to this problem. However, existing devices are not capable of receiving and securely retaining differently sized cards in both the landscape and the portrait orientation. The ability to receive differently sized cards, and to receive cards with different orientations is helpful because a worker may use the same hardhat at different jobs and with different employers. The different jobs or employers may require different cards, with different shapes.

Another important feature for worker safety is the curved outer surface of a hardhat, which is a common feature of hardhats. Curved surfaces are used so that falling objects will glance off the hardhat, rather than directly hitting a flat surface. Patent number GB 2,349,327 issued to Bennett et al. discloses a hardhat with an identification card display, wherein the upward-facing surface of the card display is completely flat. A worker could be injured if a falling object hits the flat upward-facing surface of the card display because the falling object may not slide off, potentially causing greater injury to the worker.

Some existing devices, such as U.S. Pat. No. 5,452,479 issued to Mostert, disclose caps that are capable of receiving a card or other item, but do not provide a means for securely retaining the card inside the card holder.

Thus, there exists an unmet need for a hardhat or other headgear with a card holder that is connected with the headgear, where the card holder is capable of receiving cards of multiple sizes and orientations. In addition there is a need for a hardhat with a card holder where the card holder is attached to the hardhat through curved surfaces, and that securely holds the variously sized and oriented cards in place.

### BRIEF SUMMARY OF THE INVENTION

The invention comprises a hardhat or other headgear capable of receiving and displaying differently sized and differently oriented cards that contain various types of information. The information on the front of the card may, for example and not as a limitation, include the worker's name, photo, health information, security clearance, emergency contact information, or qualifications. Any or all of this information may be included on the card, or any other information that may be desired. The information may be placed on the card in any variety way, including but not limited to simply writing on the card, utilizing a bar code, a smart chip, or any other method or device known to record information on a surface.

The card is inserted in a card holder that is connected with the headgear or hardhat. The card holder is bi-directional, that is, it has channels that are capable of receiving cards in both the landscape and portrait orientation. The card holder has at least one channel capable of receiving differently sized cards in each orientation, and may have a plurality of such channels. When using a plurality of such channels, each headgear or hardhat with a card holder is capable of receiving a minimum of four differently sized cards, in two orientations.

In some embodiments, cards are secured and protected inside the card holder, between a clear card protection plate and the appropriately sized channel. The protection plate is removeably connected with the hardhat. In one embodiment the card protection plate is made of clear UV resistant material, to protect the cards from sun exposure. UV protection of the cards is beneficial to people working outdoors, to ensure that the information contained on the cards remains intact.

In addition, the cards are removable, and may be changed as needed. A worker can use the same hardhat and card holder for different jobs that may have different identification or security cards. And, the card holder is hollow on the inside, to decrease the amount of weight, and so that the hardhat remains balanced.

### BRIEF DESCRIPTION OF THE VIEWS

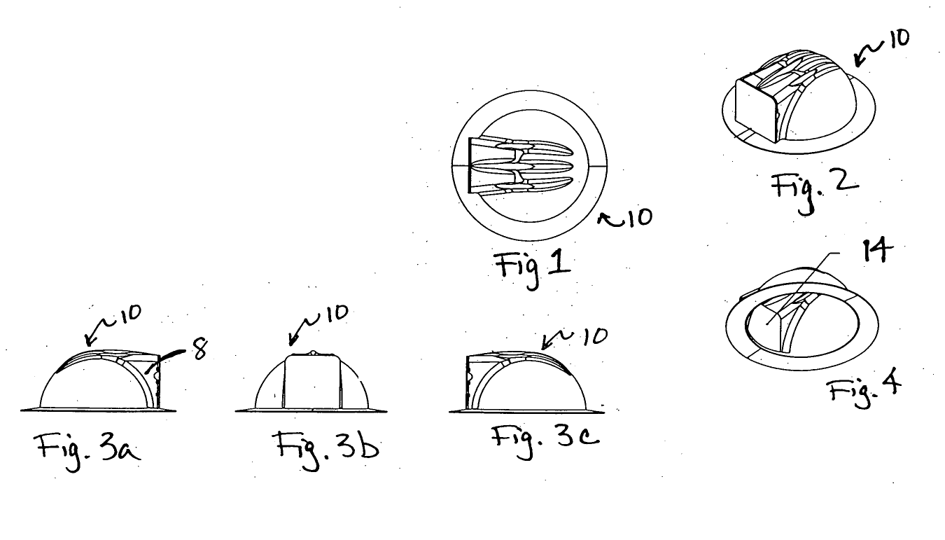

FIG. 1 is a top view of one embodiment of the invention.

FIG. 2 is a side perspective view of one embodiment of the invention.

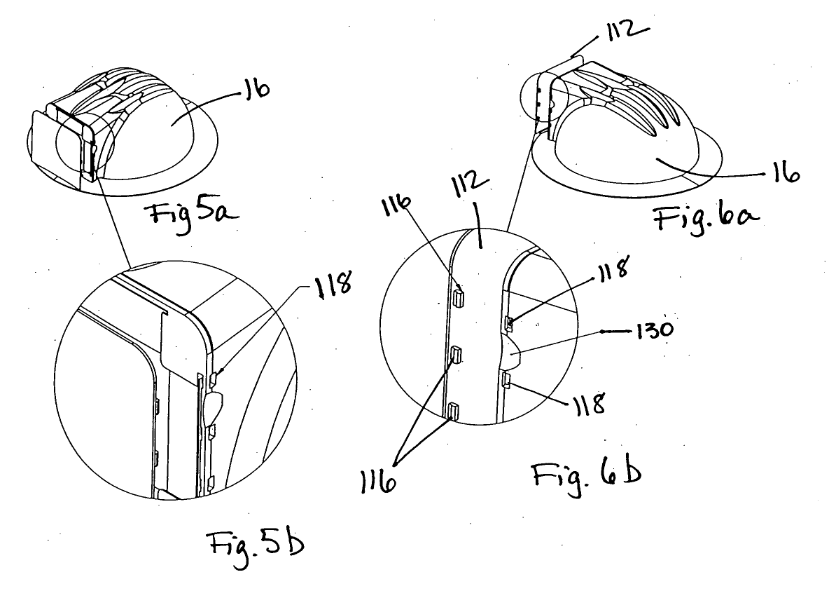

FIGS. 3a, 3b and 3c are left, front and right plane views of one embodiment of the invention.

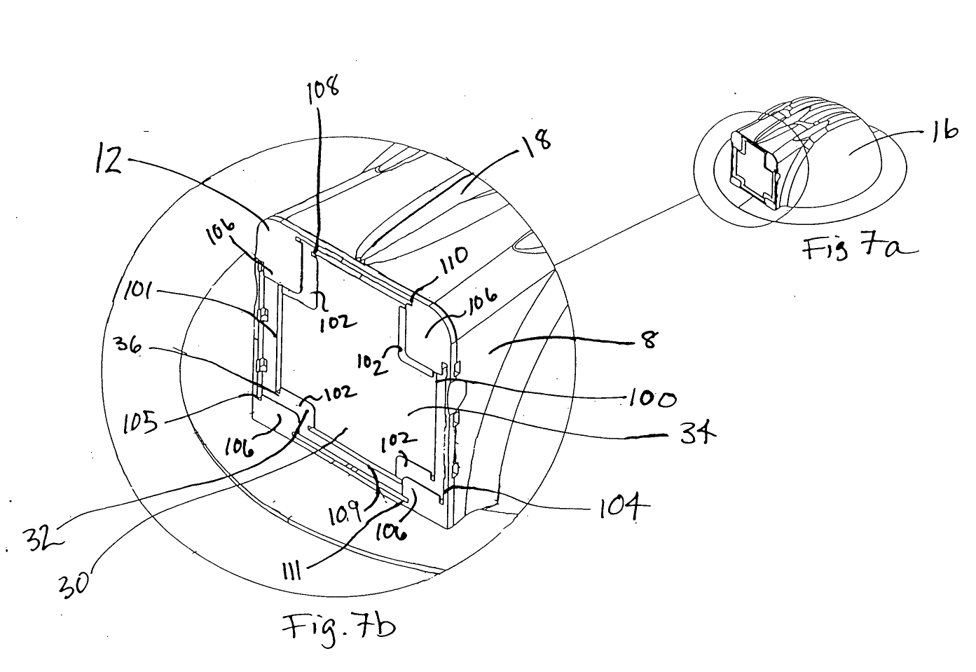

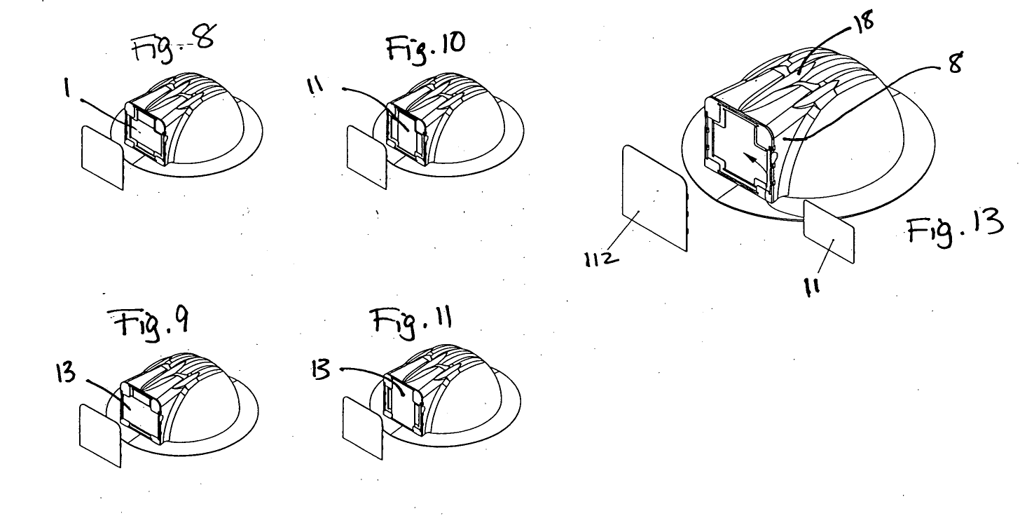

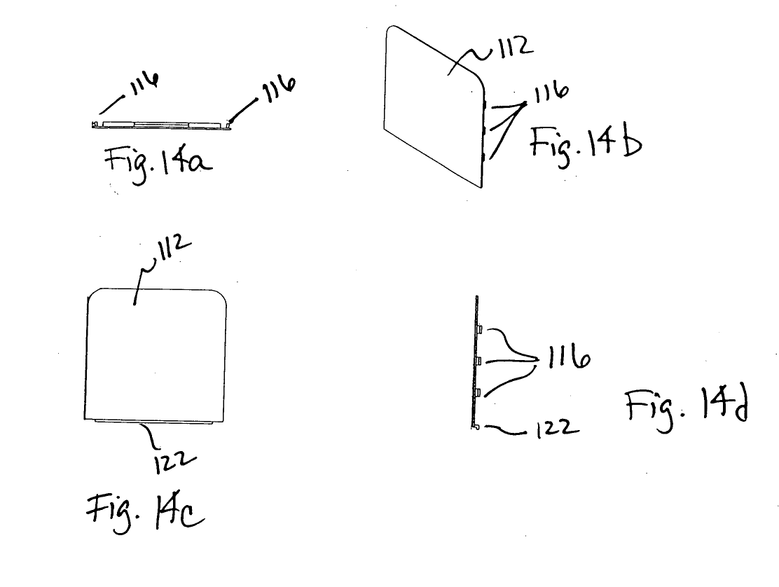

FIG. 4 is a perspective view of the bottom of one embodiment of the invention.

FIG. 5a is a perspective side view of one embodiment of the invention and

FIG. 5b is a close-up view of a portion of 5a.

FIG. 6a is a rear perspective view of one embodiment of the invention and

FIG. 6b is a close-up view of a portion of 6a.

FIG. 7a is a top, front perspective view of one embodiment of the invention and

FIG. 7b is a close-up view of a portion of 7a.

FIG. 8 is a front perspective view of one embodiment of the invention showing the use of a narrow identification card in the landscape orientation.

FIG. 9 is a front perspective view of one embodiment of the invention showing the use of a wide identification card in the landscape orientation.

FIG. 10 is a front perspective view of one embodiment of the invention showing the use of a narrow identification card in the portrait orientation.

FIG. 11 is a front perspective view of one embodiment of the invention showing the use of a wide identification card in the portrait orientation.

FIG. 13 shows the insertion and placement of a narrow card in the landscape orientation.

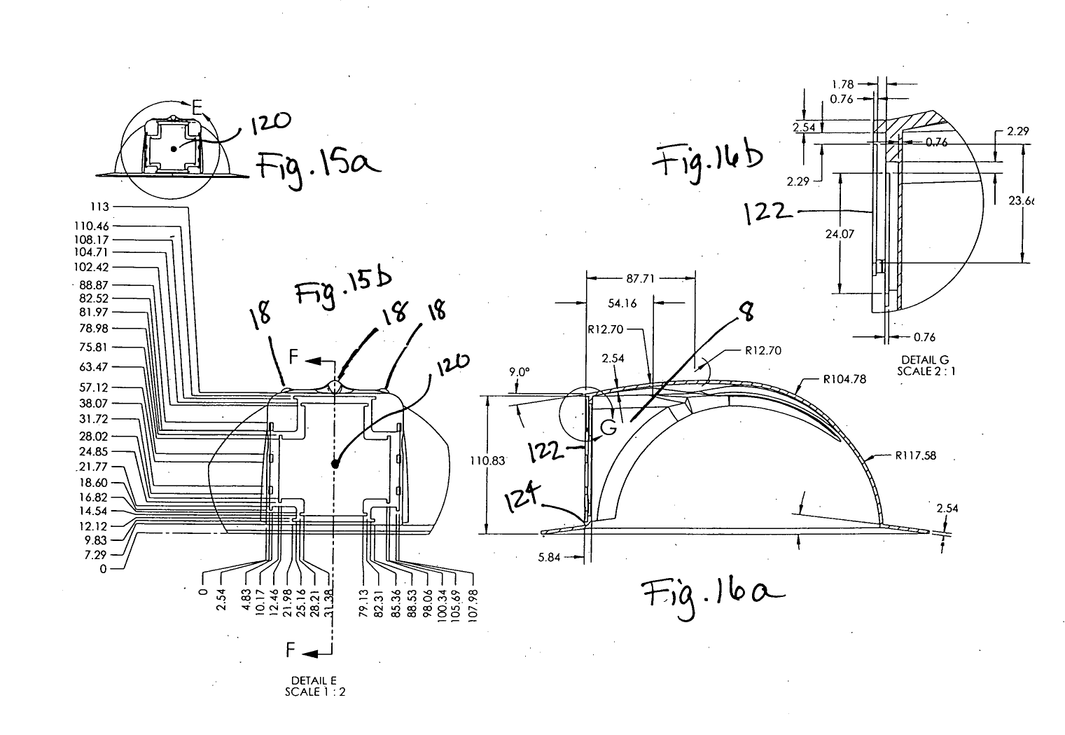

FIGS. 14a, 14b, 14c and 14d show respectively a top view, a side perspective view, a front view and a side view of one embodiment of the protection plate.

FIG. 15a is a front view of one embodiment of the invention, and FIG. 15b is a close-up view of a portion of FIG. 15b.

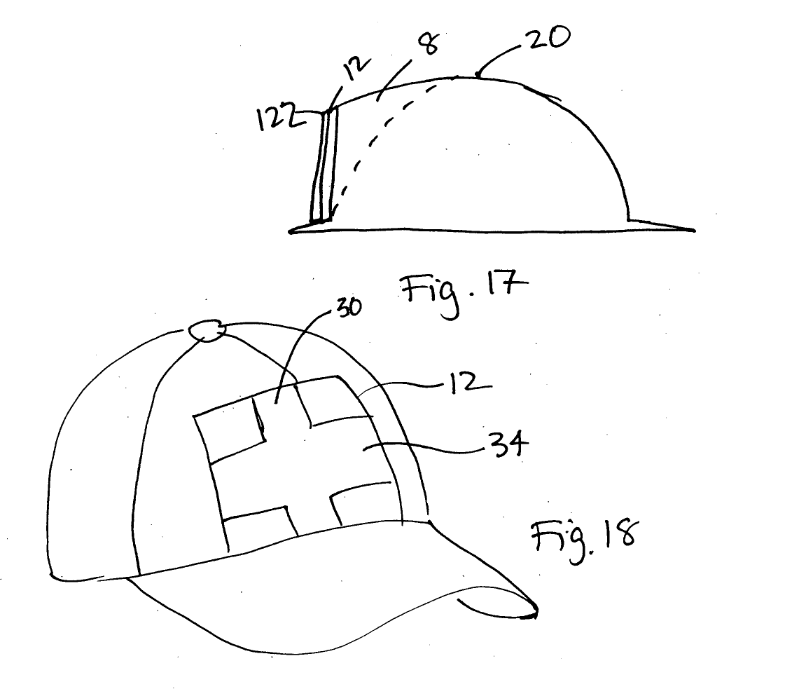

FIG. 16a is a side view of one embodiment of the invention and FIG. 16b is a close-up view of a portion of FIG. 16b.

FIG. 17 is a side perspective view of one embodiment of the invention.

FIG. 18 is a side perspective view of one embodiment of the invention.

### DETAILED DESCRIPTION

Protective headgear is often used at construction sites, by firefighters, and by others. The term “hardhat” as used in this application will include hardhats worn by construction workers, protective headgear worn by firefighters, and any other type of hard, protective headgear.

Hardhats come in a wide variety of shapes and sizes, and may sometimes have a brim, ear protection or eye protection. A common feature of hardhats is a hard, generally dome-shaped shell 16 covering the head.

A card holder 12 is located on surface 16 of the hardhat, and is connected with the outside of a hardhat. The card holder 12 may be located anywhere on the outside surface 16 of the hardhat, although in most circumstances it will likely be in the front or on one of the sides of the hardhat.

In one embodiment, card holder 12 is connected with hardhat 10 by attachment. Attachment 8 allows card holder 12 to remain perpendicular, to face directly forward, while attached to curved outer surface 16 of hardhat 10. That is, if hardhat 10 where placed on a horizontal surface, attachment 8 ensures that card holder 12 remains perpendicular to that horizontal surface. In another embodiment, card holder 12 is connected with hardhat 10 without attachment 8. In this embodiment, card holder 12 will not be perpendicular to a horizontal surface, but will conform to the curved exterior surface 16, and will therefore be tilted relative to a horizontal surface.

Hardhats are typically produced by injection molding which forms the unitary, solid, generally curved exterior surface 16 of a hardhat. The dome shape is used because of the inherent strength of a curved surface, and because objects falling or hitting a curved surface tend to glance or slide off the curved surface.

The card holder is connected with dome-shaped surface 16 by a curve. A continuous curve runs from the top of the hardhat to the far edge of the card holder 12. The continuous curve may be formed by one or more rails 18 that are raised from the generally dome-shaped surface 16. Alternatively, the continuous curve may be a smooth, non-railed, curve 20 that is the integral with the curve formed by dome-shaped surface 16. The curve, whether formed by one or more rails 18, or by curved surface 20, is an important safety feature. The continuous curve helps ensure that objects striking the hardhat will slide or glance off the hardhat, rather than directly impacting the hardhat.

In one embodiment the card holder 12 is permanently connected with the exterior surface 16 of the headgear. That is, the exterior surface of the hardhat is formed with the card holder in place. Alternatively, the card holder 12 may be permanently connected with the dome-shaped shell 16 by glue or other fixatives known in the art. In yet another embodiment card holder 12 is removeably connected with exterior surface 16 by any means known in the art, including but not limited to tabs or hook and fastener systems.

In all cases, the underside 14 of surface 16 that is behind card holder 12, and specifically including attachment 8, is hollow. Hollow cavity 14 ensures that the hardhat 10 remains balanced, reduces the weight of the hardhat.

The card holder is sized to receive card 11 or 13 bearing information on the front of card 11 or 13. The information may be of any type desired. Non-limiting examples of such information are photo identification, worker identification, worker qualifications, health information, or security clearances.

The card holder is comprised of at least two vertical channels 30 and 32, and at least two horizontal channels 34 and 36. In one embodiment, a first narrow vertical channel 30 may be approximately 2⅛ inches wide and 3⅜ inches long to receive a standard credit card-sized card 11 in the portrait orientation. A second wider vertical channel 32 may be approximately 2.875 inches wide and 3.375 inches long to receive a standard military-sized photo identification card, also in the portrait orientation. It is obvious that first vertical channel 30 is narrower than second vertical channel 32.

Card holder 12 also contains two horizontal channels 34 and 36. In one embodiment, a first narrow horizontal channel 34 may be approximately 2⅛ inches wide and 3⅜ inches long to receive a standard credit card-sized card in the landscape orientation. A second wider horizontal channel 36 may be approximately 2.875 inches wide and 3.375 inches long to receive a standard military-sized photo identification card also in the landscape orientation. It is again obvious that first horizontal channel 34 is narrower than second horizontal channel 36.

These sizes are given because they are standard card sizes used in the industry. The length and width of the channels may be modified as needed to fit any size card.

The channels are formed by certain projections. The first narrow horizontal channel 34 is connected with insertion slot 100. Insertion slot 100 is sized to receive card 11, and is formed by two retaining surfaces 102. There may be one or two insertion slots for each card. In one embodiment, there will be only one insertion slot 100, and in another embodiment there will be two insertion slots 100 and 101, so that the information card 11 may be inserted from either the left- or right-hand side of the card holder 12.

Retaining surface 102 also serves as a seating surface 102 for the wider horizontal card. Retaining/seating surface 102 may be any shape that can both retain information card 11 behind retaining/seating surface 102 and can provide support for the wider information card in the wider horizontal channel. There are a minimum of four retaining/seating surfaces 102 for the horizontal channels; two located closer to insertion slot 100 or 101 of narrow channel 34 and two that are located at the other end of narrow channel 34.

Information card with information in landscape orientation, and sized to correspond to the size of narrow horizontal channel 34, is slipped in insertion slot 100 (or insertion slot 101) and pushed underneath the two retaining/seating surfaces 102 that are closest to the insertion point. The user slides the card horizontally across narrow horizontal channel 34 and underneath the two other retaining/seating surfaces 102 that are further from the insertion point until the card is fully within narrow horizontal channel 34.

A wider horizontal information card is inserted in a similar manner. The wider card is inserted in insertion slot 104 or 105. Insertion slots 104 and 105 are sized to receive a wider information card 13, and are formed by two retaining surfaces 106, one on each side of insertion slot 104. In one embodiment, there will be only one insertion slot 104, and in another embodiment there will be two insertion slots 104 and 105, so that the information card may be inserted from either the left- or right-hand side of the card holder.

The wider horizontal information card 13 is inserted in insertion slot 104 (or 105) and the user slides the card horizontally in channel 36 underneath the two retaining surfaces 106 that are closest to the point of insertion. The back of wide information card 13 rests on the two retaining/seating surfaces 102 that are closest to the point of insertion. The user continues to slide the card through wide horizontal channel 36, and underneath the two retaining surfaces 106 that are furthest from the point of insertion until card 11 is fully inside horizontal channel 36.

The two vertical channels 30 and 32 operate in a similar manner. Narrow vertical channel 30 may have one or two insertion slots 108 and 109 that are sized to receive a narrower information card 11 containing information in portrait orientation. Narrow information card 11 is inserted into insertion slot 108 (or 109), and slid under the two retaining/seating surfaces 102 that are closest to the point of insertion. The user continues to slide card 11 until it is underneath the two retaining/seating surfaces 102 that are furthest from the point of insertion and fully within vertical channel 30.

Wide vertical channel 32 has one or two insertion slots 110 and 111. Insertion slots 110 and 111 are sized to receive cards 13 containing information in portrait orientation. The user slides card 13 underneath retaining surfaces 106 that are closest to the insertion slots. The back of information card 13 rests against the two retaining/seating surfaces 102 that are closest to the insertion slots. The user continues to slide card 13 through wide vertical channel 32, and underneath the two retaining surfaces 106 that are furthest from the point of insertion until card 13 is fully inside vertical channel 32.

In one embodiment, there may be a bard or other convex surface 120 that supports the back of information card 11 or 13. Bard 120 helps stabilize the card, and keeps the card in place.

In other embodiments there may be one, or three or more channels in each direction. In yet other embodiments, bi-directional card holder 12 may be connected with any type of headgear, including but not limited to, caps, baseball caps, beanies, or any other soft or hard apparel used to cover the head. In these embodiments, protective plate 112, described below, may or may not be present.

A clear, rigid protection plate 112 is connected with the card holder 12. Protection plate 112 may be permanently connected with card holder 12 or may be removeably connected with card holder 12. When protection plate 112 is in place, it covers and protects information card 11 or 13, while the see-through aspect of protection plate 12 makes it possible to read the information contained on card 11 or 13.

In one embodiment, protection plate 112 is removeably connected with the card holder by tabs 116 that connect with keeper slots 118. Tabs 116 are lined up with keeper slots 118 and protection plate 112 is snapped into place. In one embodiment protection plate 112 will be ultra-violet (“UV”) resistant. This is beneficial to outdoor workers, to prevent the sun from discoloring, fading, or otherwise damaging the information card.

In yet another embodiment, protection plate 112 may have a lip 122 that fits into slot 124 in exterior surface 16 to help stabilize and retain protection plate 112.

In one embodiment, exterior surface 16 contains at least one finger notch 130 to allow for easier removal of protective plate 112.

Various changes and modification to the invention will be apparent to those skilled in the art. Such changes and modifications may be made without departing from the spirit and scope of the present invention. The embodiments disclosed herein are to be considered in all respects as illustrative and not restrictive, and the scope of the invention is as stated in the claims rather than by the foregoing description. All changes that come within the meaning and range of equivalency of the claims are intended to be embraced therein.

What is claimed is:

1. A bi-directional card holder for protective headgear, comprising:
a protective headgear with a dome-shaped exterior surface,
a bi-directional card holder connected with said exterior surface by an attachment and a continuous curve wherein said bi-directional card holder comprises:
a narrow insertion slot connected with a first narrow vertical channel wherein said narrow insertion slot and said narrow vertical channel are sized to receive a narrow card inserted in a portrait orientation, wherein said card has a front and a back and the front contains information, wherein said card is removeably inserted in said narrow vertical channel through said narrow insertion slot, and wherein said card is retained in said narrow vertical channel by a plurality of retaining/seating surfaces,
a wide insertion slot connected with a second wide vertical channel wherein said wide insertion slot and said wide vertical channel are sized to receive a wide card inserted in a portrait orientation, wherein said card has a front and a back and the front contains information, wherein said card is removeably inserted in said wide vertical channel through said wide insertion slot, and wherein said back of said card rests on said retaining/seating surfaces and the front of said card is retained in said wide vertical channel by a plurality of retaining surfaces,
a narrow insertion slot connected with a first narrow horizontal channel wherein said narrow insertion slot and said narrow horizontal channel are sized to receive a narrow card inserted in a landscape orientation, wherein said card has a front and a back and the front contains information, wherein said card is removeably inserted in said narrow horizontal channel through said narrow insertion slot, and wherein said card is retained in said narrow horizontal channel by a plurality of retaining/seating surfaces,
a wide insertion slot connected with a second wide horizontal channel wherein said wide insertion slot and said wide horizontal channel are sized to receive a wide card inserted in a landscape orientation, wherein said card has a front and a back and the front contains information, wherein said card is removeably inserted in said wide horizontal channel through said wide insertion slot, and wherein said back of said card rests on said retaining/seating surfaces and the front of said card is retained in said wide vertical channel by a plurality of retaining surfaces,
and a clear, rigid card protection plate connected with said bi-directional card holder.

2. The bi-directional card holder of claim 1 wherein said card holder is permanently connected with said protective headgear.

3. The bi-directional card holder of claim 1 wherein said card holder is removeably connected with said protective headgear.

4. The bi-directional card holder of claim 1 wherein said protection plate is resistant to ultraviolet radiation.

5. The bi-directional card holder of claim 1 wherein said protection plate is permanently connected with said card holder.

6. The bi-directional card holder of claim 1 wherein said protection plate is removeably connected with said card holder.

7. The protection plate of claim 6 wherein said protection plate has a plurality of tabs that correspond to a plurality of keeper slots to removeably connected said protection plate with said card holder, and wherein said protection plate has a lip that removeably connects with a slot in said exterior surface of said headgear.

8. The protection plate of claim 6 wherein said exterior surface contains at least one finger slot to assist with removal of said protection plate.

9. The bi-directional card holder of claim 1 wherein said card holder is connected with said exterior surface by a curved surface, wherein said curved surface is selected from the group consisting of rails and a curve.

10. The bi-directional card holder of claim 1 wherein the underside of said exterior surface behind said card support defines a hollow cavity.

11. The bi-directional card holder of claim 1 wherein said card holder comprises three or more vertical channels and three or more horizontal channels.

12. A bi-directional card holder, comprising:
a narrow insertion slot connected with a first narrow vertical channel wherein said narrow insertion slot and said narrow vertical channel are sized to receive a narrow card inserted in a portrait orientation, wherein said card has a front and a back and the front contains information, wherein said card is removeably inserted in said narrow vertical channel through said narrow insertion slot, and wherein said card is retained in said narrow vertical channel by a plurality of retaining/seating surfaces,
a narrow insertion slot connected with a first narrow horizontal channel wherein said narrow insertion slot and said narrow horizontal channel are sized to receive a narrow card inserted in a landscape orientation, wherein said card has a front and a back and the front contains information, wherein said card is removeably inserted in said narrow horizontal channel through said narrow insertion slot, and wherein said card is retained in said narrow horizontal channel by a plurality of retaining/seating surfaces.

13. The bi-directional card holder of claim 12 wherein said card holder has a plurality of channels, wherein each additional vertical channel comprises:
an additional wide insertion slot connected with an additional wide vertical channel wherein said wide insertion slot and said wide vertical channel are sized to receive a wide card inserted in a portrait orientation, wherein said card has a front and a back and the front contains information, wherein said card is removeably inserted in said wide vertical channel through said wide insertion slot, and wherein said back of said card rests on said retaining/seating surfaces and the front of said card is retained in said wide vertical channel by a plurality of retaining surfaces,
and each additional horizontal channel comprises:
an additional wide insertion slot connected with an additional wide horizontal channel wherein said wide insertion slot and said wide horizontal channel are sized to receive a wide card inserted in a landscape orientation, wherein said card has a front and a back and the front contains information, wherein said card is removeably inserted in said wide horizontal channel through said wide insertion slot, and wherein said back of said card rests on said retaining/seating surfaces and the front of said card is retained in said wide vertical channel by a plurality of retaining surfaces.

14. The bi-directional card holder of claim 12 wherein said card holder is connected with a soft hat.

15. The bi-directional card holder of claim 12 wherein said card holder is connected with a hardhat.

16. The bi-directional card holder of claim 12 wherein a clear, rigid card protection plate is permanently connected with said bi-directional card holder.

17. The bi-directional card holder of claim 12 wherein a clear, rigid card protection plate is removeably connected with said bi-directional card holder.
